(19) United States
(12) Patent Application Publication
(10) Pub. No.: US 2010/0294801 A1
(43) Pub. Date: Nov. 25, 2010

(54) Reusable, Pressurize-able, and Flexible Dispenser Pack for Heating or Cooling Liquids or Food

(75) Inventors: Fred Fulcher, Los Angeles, CA (US); Andrew B. Huang, Rancho Palos Verdes, CA (US)

Correspondence Address: ANDREW B. HUANG, 28442 LOMO DR., RANCHO P.V, CA, 90275, US

(73) Assignee: Bodahgear, LLC

(21) Appl. No.: 12/470,298

(22) Filed: May 21, 2009

(51) Int. Cl. B65D 30/10; B65D 33/00; B67D 5/62

(52) U.S. Cl. 222/94; 222/105; 222/106; 222/146.1

(57) ABSTRACT

A reusable, pressurize-able, foldable and flexible dispenser pack for hot or cold liquids or food is described as consisting an insulation jacket, an enclosed chemical bladder and an innermost product bladder. The chemical bladder contains exothermic material when activated would produce heat and pressure. The chemical and product bladders are formed to be easily accessible to the insides of the bladders for refilling chemicals and products, respectively. When used specifically for heating water, the dispenser pack can be fitted with a shower head for showering; or a coffee/espresso filter bead for making fresh brewed coffee or espresso.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of The Invention

The present invention relates to a dispenser pack for dispensing pressurized hot or cold liquids or food. In particular it is related to a reusable, pressurize-able and flexible dispenser pack with an insulation jacket; an inner chemical bladder with self-heating or cooling capability; and an innermost liquid or food containing bladder to be heated or chilled. Additionally, the present invention relates to a combination of accessory features for added convenience as part of the dispenser pack.

2. Art Background

Hot water is used for a number of essential purposes in the outdoors, from personal hygiene; cleaning and shower, to preparing hot beverages and re-hydrating compressed foods. An “outdoor” environment may include places and activities as related to camping, hiking, sailing, rock-climbing, watching a football game in a stadium, or attending an outdoor concert. Military deployment is an example of a more arduous outdoor activity, where hot water serves numerous essential purposes but remains difficult to obtain.

In the case of military deployment, a field kitchen typically uses fuel-fired burners to heat water in large stockpots. For hot beverages; water is first heated to a boil; then, transferred to insulated beverage dispensers; and, finally transported throughout the field. Alternatively, mounted personnel may be supported by Mounted Water Ration Heaters, which are available for use in vehicles (e.g. Abrams, Bradley, HMMWV, and STRYKER).

Military deployment tends to operate in less-than-desirable environments. There is often insufficient personnel and equipment available to distribute hot water throughout the field, particularly for small groups of infantry personnel operating remotely. Furthermore, hot water is typically consumed quickly, or cools when stored for an extended period. The military's developmental “Unitized Group Ration-Express” (“UGR-E”) will provide group meals to groups of personnel operating away from the field kitchen or squad stove assets, but it does not currently include a water heating capability to provide hot beverages or hot water. The desire for a hot beverage has been expressed as a recurring need through field evaluation at Ft. Richardson, Ak.

Accordingly, there has been a need for a reusable, heavy duty, pressurize-able, tote-able, multi-serving, and self-heating instant hot water or beverage dispenser to support small group forces operating remotely.

In addition to military applications, such a reusable pressurize-able hot or cold dispenser pack could also be quite useful in civilian, emergency, disaster relief and recreational applications, where hot beverages are desired and often essential.

A few U.S. Patents have attempted to address some of the aforementioned needs. U.S. Pat. Nos. 5,715,992, 5,909,841 and 6,196,452, issued to Andrews Sr. et al, (collectively “Andrews”) disclose a beverage container including an outer shell, a flexible bladder within the shell, a mouth and a handle. Its assembly is awkward and confusing. These inventions do not address all of the above-mentioned needs.

U.S. Pat. No. 6,228,011 issued to Takemura et al., also discloses a bladder-in-carton dispenser for carrying liquid. However, Takemura does not disclose an effective heat management methodology either, since the inner bladder is adhered to the inside surface of the carton. Takemura further lacks a handle assembly, making it less useful when it is used with large amount of liquid, especially when the liquid may be hot.

None of the above or existing inventions are pressurize-able. They do not teach the embodiments of the present invention or provide the benefits disclosed below.

### SUMMARY OF THE PRESENT INVENTION

The following presents a simplified summary of some embodiments of the invention in order to provide a basic understanding of the invention. This summary is not an extensive overview of the invention. It is only intended to identify key/critical elements of the invention or to delineate the scope of the invention. Its sole purpose is to present some embodiments of the invention in a simplified form as a prelude to the more detailed description that is presented later. It shall be further noted that for the ease of describing the embodiments without limiting its scope, in the ensuing discussions, the term “pressurize-able dispenser pack for hot or cold liquids or food” will be simply addressed as “dispenser pack”.

The dispenser pack in accordance with the present invention would provide up to 3.78 liters of pressurized hot beverage or hot water in an expandable self-heating pack that will be made fully reusable. The expandable pack would be produced and shipped in collapsed form (about the size of a backpack), providing a small, lightweight package that could be conveniently distributed in the field. When chemically activated, an internal heating element would preferably provide both the heat necessary to raise the temperature of the water to a desirable temperature, e.g. 170 F in 20 minutes, and the pressure. The heater element would be capable of maintaining 3.78 liters, or 16 8-ounce beverage servings, for more than two hours after the one-time heater activation.

At the time of use, the reusable self-heating pack in accordance with the present invention would be unfolded and filled with potable water. To conveniently prepare hot coffee, hot cocoa, cappuccino or tea, pre-packaged beverage sachets, like those currently used in the military's Unitized Group Ration (UGR) (e.g. the coffee filter pack), could be inserted into the inside chamber of the dispenser pack. Depending on cost, convenience and customer requirements, various beverage sachets could be packaged with or within the self-heating dispenser pack at the time of manufacture to further improve the convenience of the package. The self-heating dispenser pack could also be used with the recently developed military Drink-Pack beverage bladders, which contain an instant beverage and include a re-sealable zipper closure that eliminates the need for additional cups. Furthermore, special-purpose rations, including the Go-To-War Ration, could be coupled to cases of Long-Rang-Patrol and Cold-Weather Rations to provide groups of 12 to 18 personnel hot water for preparation of hot beverages and/or ration hydration.

The embodiment of the dispenser pack of the present invention has the following salient characteristics. The pack would consist of a reusable jacket; an enclosable reusable water and gas tight heater bladder; and, an innermost water or product bladder. The heater bladder and the product bladder may be separate bladders or configured in a “bladder-in-bladder” arrangement. After unfolding the dispenser pack, the water or product bladder could be filled with up to 3.78 liters of water or product.

The outer insulating jacket could be made of ballistic nylon, PE foam or other flexible materials with good insulation and pressurize-able properties. The jacket would have zipper openings allowing access to the inside chamber that holds the inner bladder or bladders. Foam like materials would serve both as an insulation for the internal heating package (heating element and heater bladder), and as a heating (or cooling) chamber for heating (or cooling) a can, bottle, shelf-stable tray food, or zipper bladder containing various food, from the outside. Heating can be achieved by adding heating elements while cooling can be achieved by adding cooling chemicals.

The heating element would be placed in the inside heater bladder for heating the contents of the water or product in the inner bladder. The heating element may be any exothermic chemicals that generate heat and gases, e.g. magnesium ferrite alloy (MgFe alloy) or other similar chemicals. Such chemicals can be activated by adding water or other reagents. The activation water can be added from the outside through a port into the inside heater bladder. Water can also be self-contained with the MgFe alloy and activated when a separate water-containing bladder is torn open by a pull string mechanism.

The pressurize-able aspect of the dispenser pack allows it to be used in new and novel ways. When fitted with a showerhead, the dispenser pack would provide ample fast flowing hot water for outdoor showers. When fitted with a coffee or espresso filter head, fresh coffee or espresso can be brewed.

### BRIEF DESCRIPTION OF THE DRAWING FIGURES

FIG. 1 depicts a perspective view of pressurize-able dispenser pack for hot or cold liquids or food in accordance with the present invention.

FIG. 2 depicts a perspective view of the innermost liquid or product bladder positioned inside of the outer heater bladder in a “bladder-in-bladder” configuration in accordance with the present invention.

FIG. 3 depicts a perspective view of the insertion of the heating chemical element into the inside heater bladder through the heater bladder opening and the unzipped insulation jacket according to the present invention.

FIG. 4 depicts a perspective view of another embodiment of the dispenser pack as described in the present invention. Specifically FIG. 4 depicts a dispenser pack to be used for heating prepackaged “liquids or products” and the method by which the innermost liquid or product bladder is inserted into the dispenser pack.

FIG. 5 describes in additional detail of the method by which the innermost prepackaged liquid or product bladder is positioned for heating and the construction of the inner heater bladder, in accordance with the present invention.

FIG. 6 depicts a view of an attached showerhead fitted to the innermost bladder that contains pressurized water for using the embodied invention as a hot water shower in accordance with the present invention.

FIG. 7 depicts another view of an attached coffee or espresso filter-head fitted to the innermost bladder that contains pressurized water for using the embodied invention to brew hot coffee or espresso, in accordance with the present invention.

### DETAILED DESCRIPTION OF THE PREFERRED EMBODIMENTS

In the following description, various embodiments of the present invention will be described. For purpose of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

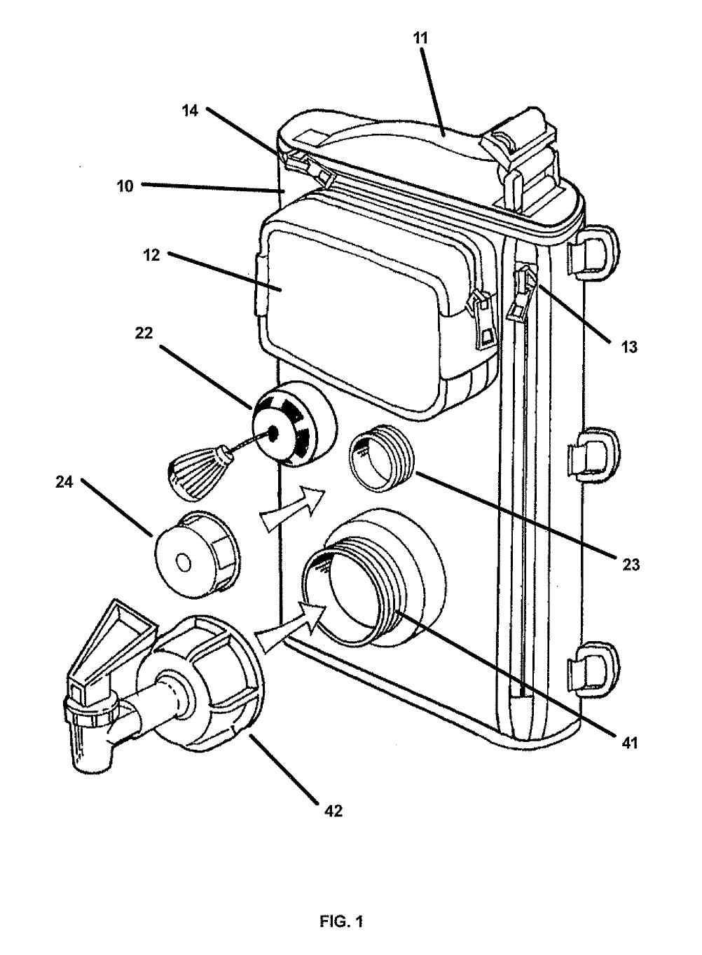

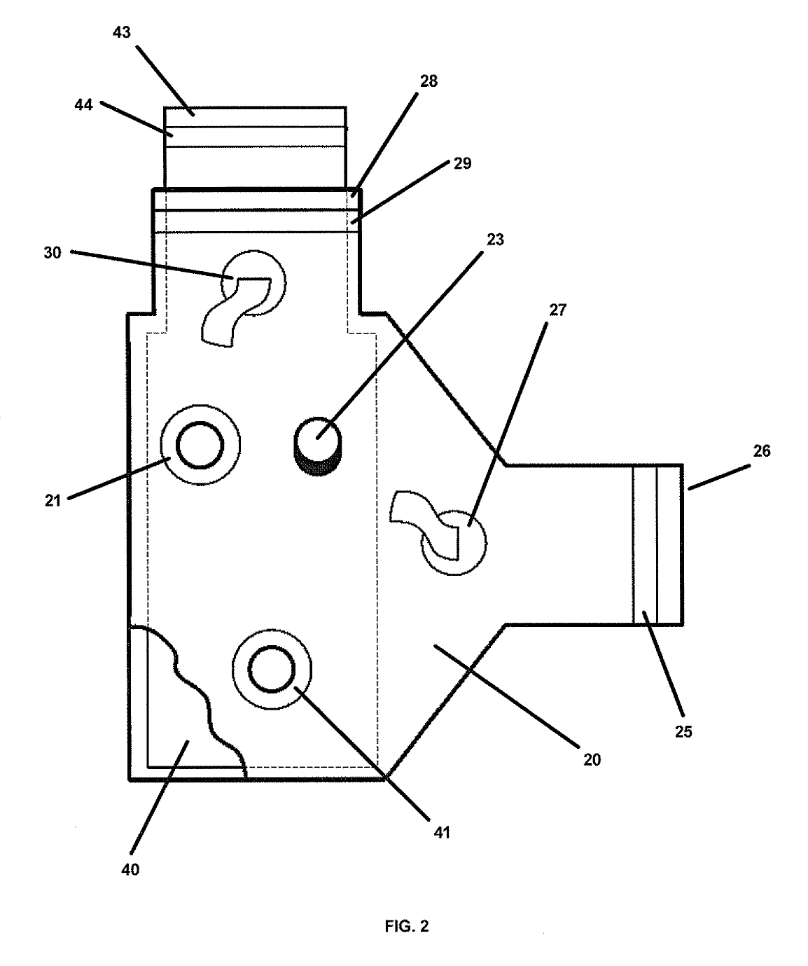

In FIG. 1 depicts a perspective view of the pressurize-able dispenser pack for hot or cold liquids or food in accordance with the present invention. The dispenser pack consists of an outer insulation jacket 10. The outer insulating jacket 10 could be made of ballistic nylon, PE foam or other flexible materials with good insulation and elastic properties. The reusable jacket 10 is constructed to allow the building up of pressure for the pressurized release of the enclosed heated liquid when the dispenser is activated. A strap tote device 11 may be affixed on top of the jacket 10 to facilitate the carrying of heavy quantities of liquids or foodstuff. An accessory pocket 12 may likewise be affixed to the outside of jacket 10 for holding cups, heating chemicals, dispenser attachments etc. On the side of jacket 10 is a zipper 13 when opened allows access to the inside chamber of the jacket 10 that holds the inner bladders (not shown in FIG. 1). Similarly on the top side of jacket 10 is a zipper 14. When zipper 14 is opened, the inside chamber of the jacket 10 that holds the inner bladders are accessible. Extending perpendicularly out from jacket 10 is a threaded port 23. Port 23 is “leak-proof” bonded to the wall of bladder 20 (not shown in FIG. 1, shown in FIG. 2). After the initial insertion of the heater element into the inside heating bladder 20, port 23 is an entry way by which water or reagent is poured into the inside reaction bladder 20 to initiate the exothermic chemical reaction for heating. Once the chemical reaction has started, a cap 24 is secured onto port 23 to contain the chemical reaction generating both heat and pressure. Also extending from the inside heater bladder 20 (not shown in FIG. 1) and out of the jacket 10 is the over-pressure valve 22. Valve 22 would release any excess pressure formed during the exothermic reaction to prevent the dispenser pack from rupturing. Lastly, extending perpendicularly out from the innermost product bladder 40 (not shown in FIG. 1, shown in FIG. 2) and out of the jacket 10 is the threaded product dispenser port 41. Port 41 is “leak-proof” bonded to the walls of the bladders 20 and 40. For dispensing hot water or hot liquid products, a liquid dispenser attachment 42 is used. The dispenser attachment 42 would be affixed onto the product dispenser port 41.

In FIG. 2, the inside heater bladder 20 and the innermost liquid or product bladder 40 are described in greater detail. As shown, the inner bladder 20 and the innermost bladder 30 are in a “bladder-in-bladder” configuration.

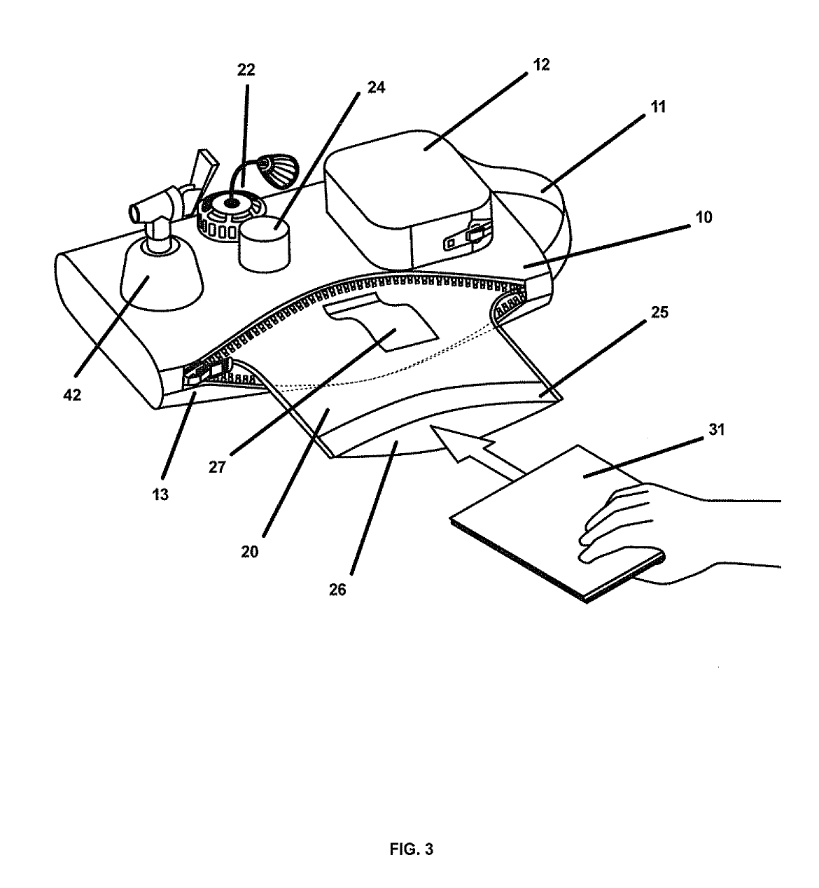

The inside heater bladder 20 is formed from heavy duty reusable flexible thermal plastics, with a side opening 26 and a top opening 28. When the zipper 13 is unzipped and the opening 26 is opened, the chemical heater element 31 (not shown in FIG. 2, shown in FIG. 3) would be inserted into the heater bladder 20. A plastic rib 25 is affixed across the opening 26 and a hook and loop strap 27 is affixed on bladder 20. When the opening 26 is folded across the plastic rib 25 and then rolled closed and secured in place by hook and loop straps 27, a water and gas tight seal is formed across the opening 26. The plastic rib 25 and hook and loop straps 27 constitute a sealing means for sealing the opening 26. Similarly an opening 28 is formed on the top side of bladder 20. Likewise a plastic rib 29 is affixed across the opening 28. The plastic rib 29 and hook and loop straps 30 constitute a sealing means for sealing the opening 28. The opening 28 allows the placement of the innermost product bladder 40 into bladder 20. The combination of bladder 20 and bladder 40 constitute the “bladder-in-bladder” configuration. Extending perpendicularly from the wall of the heater bladder 20 are the threaded ports 21 and 23. Affixed to port 21 is the over-pressure valve 22 (shown in FIG. 1). Valve 22 prevents excess pressure from building up that may rupture the dispenser pack. When the cap 24 (shown in FIG. 1) is removed off of port 23, water or other chemical reagents can be poured into the heater bladder 20 through the opening for the initiation of the heating reaction.

The innermost bladder 40 is positioned inside the heater bladder 20 through the opening 28. For multiple usages, the liquid or product bladder 40 is formed from heavy duty reusable flexible thermal plastics with a top opening 43. Liquids or products to be heated would be placed into the product bladder 40 through the opening 43. A plastic rib 44 is affixed across the opening 43. When the opening 43 is folded across the plastic rib 44 and then secured by hook and loop straps 30, any water or product inside of bladder 40 would be sealed for heating. A threaded port 41 would be affixed to the innermost bladder 40. The port 4land bladder 40 are “leak-proof” bonded together. The port 41 would extend through the side wall of the inner heater bladder 20. Heated liquids or products would exit through this port 41.

The above “bladder-in-bladder” configuration is ideally suited for the multiple heating and dispensing of large quantities of water in the field. Prior to heating, water and the heater element 31 (shown in FIG. 3) would be inserted. After use, this configuration of bladders allows the easy removal of bladder 40 from bladder 20 for cleaning.

FIG. 3 shows the process of inserting the chemical heater element 31. Chemical heater element 31 can be MgFe alloy material or other similar exothermic chemicals. For ease of handling, element 31 made be in the form of a pad or wafer. Prior to heating the enclosed liquids or products, the insulation jacket zipper 13 would be first unzipped. The hook and loop straps 27 (shown in FIG. 2) would be unfastened and the opening 26 can be unrolled and opened. Through the opening 26, fresh or used chemical heater pads would be inserted or removed. The procedure would be reverse to close up the bladder 20 for each heating cycle.

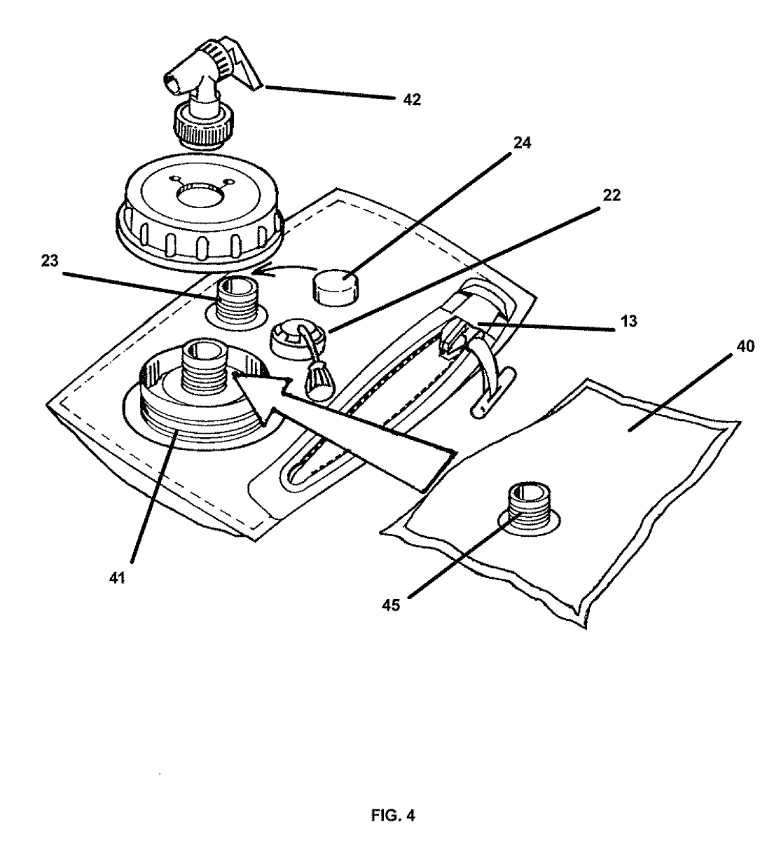

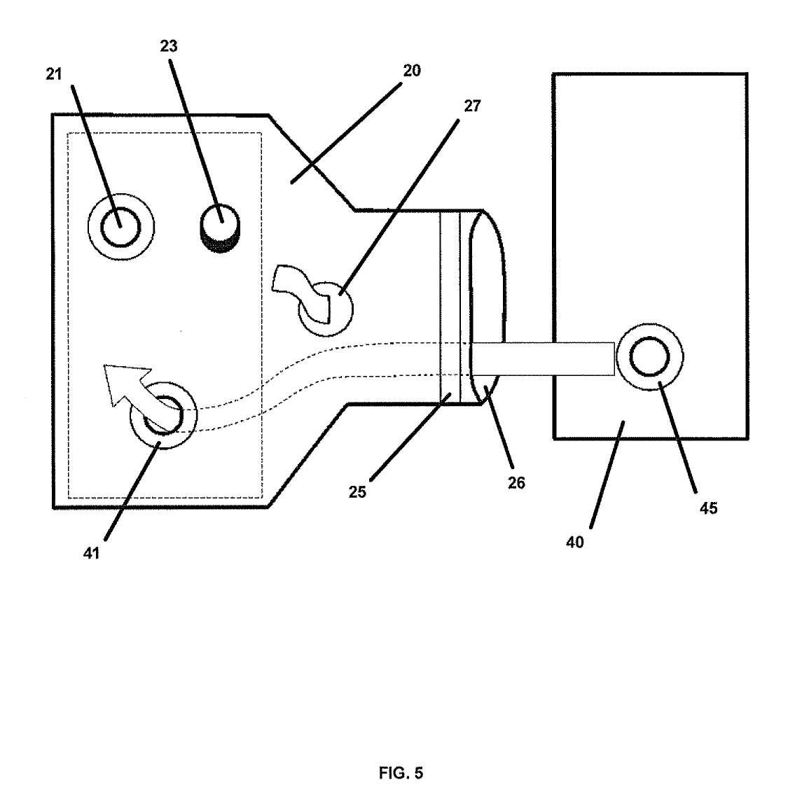

FIG. 4 shows another embodiment of the present invention. For prepackaged liquids or food products, the innermost product bladder 40 would be a sealed bladder with a threaded port fitment 45. The bladder 40 will no longer have a top opening 43. Likewise bladder 40 would not need a plastic rib 44. Liquid or food product would be sealed inside. The only attachment to bladder 40 is the port fitment 45. Port 45 is “leak-proof” bonded perpendicular to the side wall of bladder 40. The innermost bladder 40 may be formed from less expensive one-time use plastics. Prior to heating the enclosed liquids or products, the insulation jacket zipper 13 would be first unzipped. The hook and loop strap 27 would be unfastened and opening 26 can be unrolled and unfolded through the opening 26 (shown in FIG. 5), the prepackaged product bladder 40 would be inserted; and, after use removed. The port fitment 45 would extend out of the jacket 10 through the port 41; whereby the dispenser fitment 42 would be affixed to port 41. Once the product been consumed, the spent bladder 40 would be removed for disposal through the reversal of the above procedure.

In FIG. 5, the inside heater bladder 20 and the innermost prepackaged liquid or product bladder 40 for the second embodiment of the present invention is described in greater detail. The inside heater bladder 20 is again constructed from heavy duty reusable flexible thermal plastics, with a side opening 26. Bladder 20 no longer has the top opening 28 (shown in FIG. 2). When the zipper 13 is unlocked and the opening 26 is exposed, the chemical heater element 31 (shown in FIG. 3) would be inserted into the inside bladder 20. A plastic rib 25 is affixed across the opening 26 and a hook and loop strap 27 is affixed on bladder 20. When the opening 26 is folded across the plastic rib 25 and then attached onto the strap 27, a water and gas tight seal is formed across the opening 26. The plastic rib 25 and hook and loop 27 constitute a sealing means for closing the opening 26. Extending perpendicularly from the wall of the heater bladder 20 are the threaded ports 21 and 23 (shown in FIG. 4). The ports 21 and 23 are “leak-proof” bonded perpendicularly to the side wall of the heater bladder 20. Affixed to port 21 is the over-pressure valve 22 (shown in FIG. 4). Valve 22 prevents excess pressure from building up that may rupture the dispenser unit. When the cap 24 (shown in FIG. 4) is removed off of port 23, water or other chemical reagents can be poured into the heater bladder 20 through the opening for the initiation of the heating process.

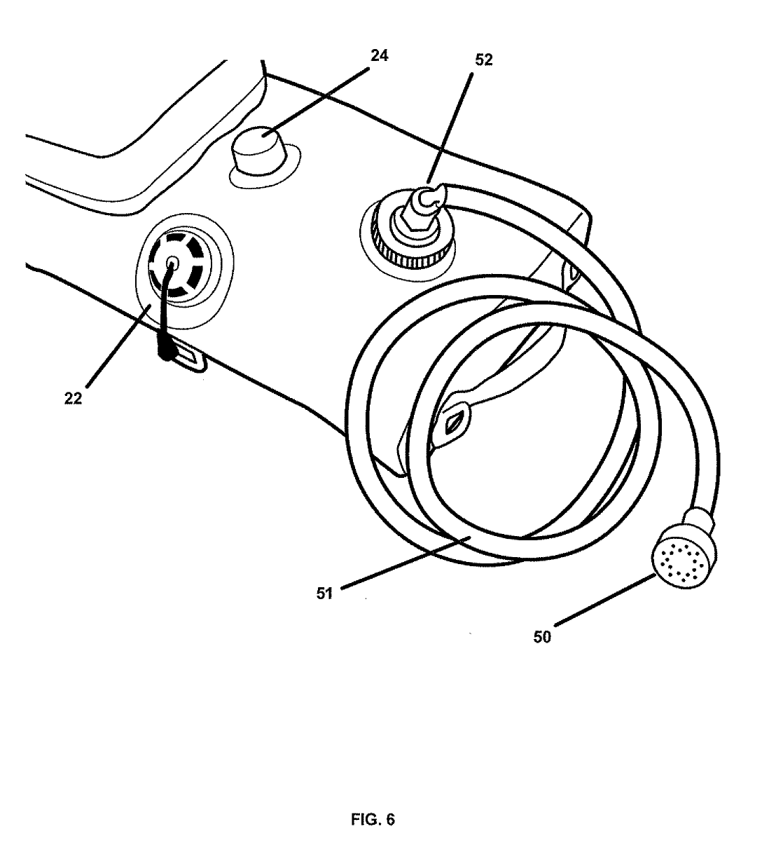

FIG. 6 depicts a method by which the present invention can supply hot shower water. A tube 51 is attached to a threaded port fitment 52 at one end and a shower head 50 at the other end. Fitment 52 is affixed to the dispenser port 41 (shown in FIG. 1). When activated, the pressure and heat of reaction would provide ample fast running hot water for showers. The dispenser pack could be hung via the strap 11 (shown in FIG. 1) to provide added water pressure for a more comfortable shower.

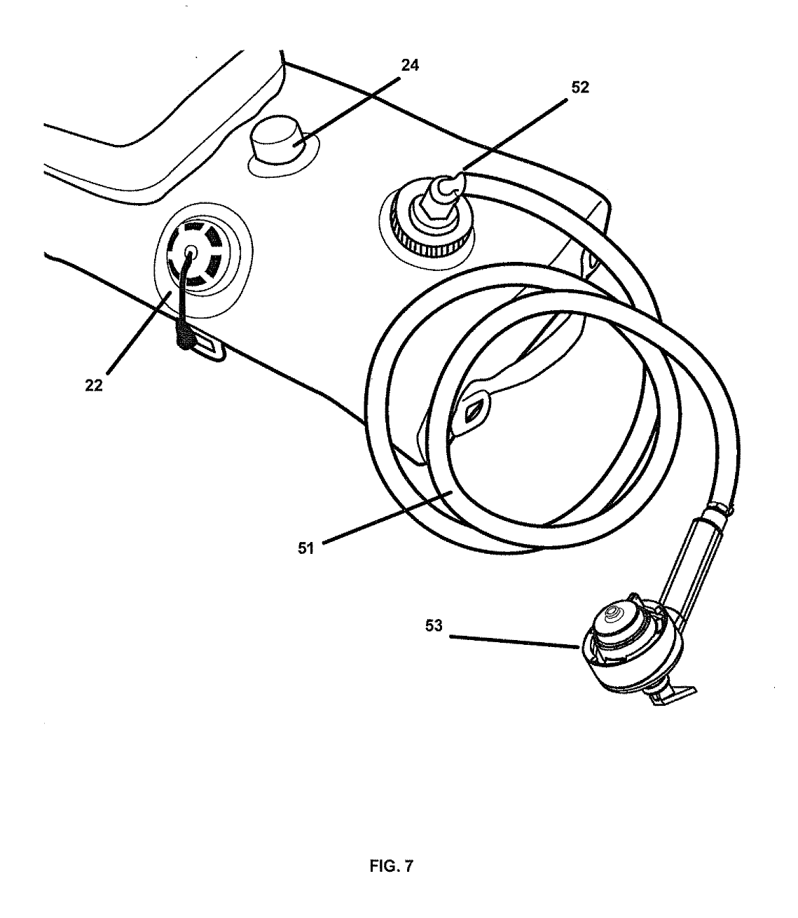

FIG. 7 describes a method by which the present invention can be used to brew hot coffee or espresso. A tube 51 is attached to a threaded port fitment 52 at one end and a coffee or espresso filter head 53 at the other end. Fitment 52 is affixed to the dispenser port 41 (shown in FIG. 1). When activated, the pressure and heat of reaction would provide ample hot pressurized water for brewing coffee or espresso. An alternatively, the coffee or espresso filter head 53 can be directly attached onto the threaded dispenser port 41 without connecting to an intermediate tube 51. The dispenser unit could be hung via the strap 11 (shown in FIG. 1) to provide added water pressure as needed.

What is claimed is:

1. A reusable, pressurize-able, foldable and flexible dispenser pack for heating or cooling liquids or food, comprising:
an outer water and air tight insulation jacket with sealable food dispenser and pressure release ports; and, leak-proof zipper means allowing access into an enclosed inside chamber;
an inner chemical bladder, positioned inside said chamber, of heavy duty reusable material with self-heating or cooling capability, with a pressure releasing means, and sealable opening means allowing access to the inside of said chemical bladder;
and, an innermost liquid or food containing bladder to be heated or chilled, positioned inside said inner chemical bladder, with a sealable port for dispensing said heated or chilled liquid or food.

2. A reusable, pressurize-able, foldable and flexible dispenser pack of claim 1, wherein:
said innermost liquid or food bladder has a sealable opening means allowing access to the inside of said bladder.

3. A reusable, pressurize-able, foldable and flexible dispenser pack of claim 1, wherein:
a shower head attachment is affixed to said insulation jacket dispenser port.

4. A reusable, pressurize-able, foldable and flexible dispenser pack of claim 1, wherein:
a coffee or espresso filter attachment is affixed to said insulation jacket dispenser port.

5. A reusable, pressurize-able, foldable and flexible dispenser pack of claim 2, wherein:
a shower head attachment is affixed to said insulation jacket dispenser port.

6. A reusable, pressurize-able, and flexible dispenser pack of claim 2, wherein:
a coffee or espresso filter attachment is affixed to said insulation jacket dispenser port.
